(19) United States
(12) Patent Application Publication
(10) Pub. No.: US 2023/0398877 A1
(43) Pub. Date: Dec. 14, 2023

(54) Cold temperature brake warning system

(71) Applicant: Damon Motors Inc., Vancouver (CA)

(72) Inventors: Dominique Kwong, Coquitlam (CA); Alexander Chau, Coquitlam (CA)

(21) Appl. No.: 17/839,130

(22) Filed: Jun. 13, 2022

(51) Int. Cl. B60L 7/26; B62L 3/02; F16D 66/00; B60T 17/22; B62J 6/24

(52) U.S. Cl. CPC B60L 7/26; B62L 3/023; F16D 66/00; B60T 17/22; B62J 6/24; F16D 2066/001; B60T 2270/604; B60T 2220/04; B60T 2270/88; F16D 2066/005; B60T 2250/04; B60T 2210/30; B60T 2230/02; B62J 3/14

(57) ABSTRACT

Complete or predominant use of regenerative braking in electric motorcycles rather than hydraulic braking may lead to brake discs and pads that are below an optimum operating temperature. To reduce the risk of accident, an indicator warns motorcycle riders that the brakes are below optimum operating temperature. With this knowledge, riders are prepared to apply extra braking force when slowing down, particularly in an emergency situation. Relative application of the regenerative brake and hydraulic brakes may be controlled to raise the temperature of the brakes so that they are primed.

### TECHNICAL FIELD

This application relates to vehicle braking. In particular, it relates to cold hydraulic brakes in a motorcycle with regenerative and hydraulic brakes.

### BACKGROUND

In the era of fully electric motorcycles, regenerative braking can be utilized to convert kinetic energy back to electrically stored energy. A regenerative braking system is used in addition to a traditional, hydraulic braking system. Regenerative braking can allow riders to slow down a motorcycle to a certain extent without the utilization of the hydraulic braking system. For example, there are scenarios when doing a light commute in which the regenerative braking may be sufficient to slow the motorcycle down without much use of the hydraulic braking system.

In hydraulic braking systems, frictional forces are generated as the brake pads are forced against a steel disc by a set of hydraulic pistons. In regenerative braking systems, magnetic forces inside an electric motor oppose the rotation of the road wheel when the motor is switched into generator mode and electrical current is drawn from it. Hydraulic brakes are generally more powerful than regenerative braking systems. Also, the hydraulic brakes by nature are more powerful because they have the capacity to be mounted on the front wheels as well as the rear wheels, whereas a regenerative braking system only brakes the rear, driving wheel. Hydraulic brakes are therefore an essential solution to slowing a motorcycle down. As well, they have the added safety feature of being anti-locking.

This background is not intended, nor should be construed, to constitute prior art against the present invention.

### SUMMARY OF INVENTION

The inventors have realized that, in scenarios where predominantly or solely the regenerative braking system has been used, the hydraulic braking system may not be primed, thus presenting a risk to riders. When regenerative braking is used for the bulk of the braking, for example at the start of a trip or in cold weather, the hydraulic brakes may not be optimally primed. The main consideration for priming a brake is temperature. Without bringing the brake disks and pads into their optimal temperature window, it will require more time and distance compared to normal in order to bring a motorcycle to a halt.

The present disclosure relates to a system and method for determining whether the hydraulic brakes in a motorcycle are primed. If the hydraulic brakes are not primed, then a warning is given to the rider. As a result of the warning, the rider can then adjust to the situation, by, for example, applying the brakes harder than would be needed if the brakes were primed. Another adjustment the rider may make is to operate both front and rear brakes while the warning is present, instead of just applying the rear brake. By making more riders aware of unprimed hydraulic brakes, then the risk of an accident caused by under-braking may be reduced. In particular, this may be beneficial when the regenerative brakes alone have been used for an extended period of time and a scenario develops when sudden, strong braking force is called for that is more than the regenerative brakes alone can provide.

Disclosed is a motorcycle comprising a rear hydraulic brake, a rear regenerative brake, an indicator and a controller, the controller configured to determine a temperature of the rear hydraulic brake, illuminate the indicator when the temperature is below a priming threshold, and extinguish the indicator when the temperature is above the priming threshold.

Also disclosed is a motorcycle comprising a rear hydraulic brake, a rear regenerative brake, a front hydraulic brake, an indicator and a controller, the controller configured to determine a temperature of the rear hydraulic brake, determine a temperature of the front hydraulic brake, illuminate the indicator when at least one of the temperature of the rear hydraulic brake and the temperature of the front hydraulic brake is below a priming threshold, and extinguish the indicator when the temperature of the rear hydraulic brake and the temperature of the front hydraulic brake are above the priming threshold.

Further disclosed is a method for warning a rider of a motorcycle that a hydraulic brake of the motorcycle is not primed comprising: determining a temperature of the hydraulic brake; determining that the temperature is below a priming threshold; and illuminating an indicator on the motorcycle.

This summary provides a simplified, non-exhaustive introduction to some aspects of the invention, without delineating the scope of the invention.

### BRIEF DESCRIPTION OF DRAWINGS

The following drawings illustrate embodiments of the invention and should not be construed as restricting the scope of the invention in any way.

FIG. 1 is a schematic drawing of a motorcycle cockpit with a cold brake warning indicator, according to an embodiment of the present invention.

FIG. 2 is a flowchart for a cold brake warning system, according to an embodiment of the present invention.

FIG. 3 is another flowchart for a cold brake warning system, according to an embodiment of the present invention.

FIG. 4 is a block diagram of components of a motorcycle with a cold brake warning system, according to an embodiment of the present invention.

FIG. 5 is a block diagram of components of another motorcycle with a cold brake warning system, according to an embodiment of the present invention.

FIG. 6 is a further flowchart for operating regenerative and hydraulic brakes, according to an embodiment of the present invention.

FIG. 7 is another flowchart for operating regenerative and hydraulic brakes, according to an embodiment of the present invention.

FIG. 8 is a schematic drawing of another motorcycle cockpit with three brake levers, according to an embodiment of the present invention.

### DESCRIPTION

### A. Glossary

### ECU—Electronic Control Unit

The term “module” can refer to any component in the disclosed system and to any or all of the features of the invention without limitation. A module may be a software, firmware or hardware module located in a motorcycle.

The term “priming” refers to raising the temperature of a brake so that it becomes more effective.

The term “priming threshold” refers to the temperature below which a brake is not primed and above which the brake is primed.

The term “processor” is used to refer to any electronic circuit or group of circuits that perform calculations, and may include, for example, single or multicore processors, multiple processors, an ASIC (Application Specific Integrated Circuit), and dedicated circuits implemented, for example, on a reconfigurable device such as an FPGA (Field Programmable Gate Array). The processor performs the steps in the flowcharts, or causes them to be performed, whether they are explicitly described as being executed by the processor or whether the execution thereby is implicit due to the steps being described as performed by code or a module. The processor may have multiple constituent processors.

The term “system”, if not otherwise qualified, relates to the subject of the disclosure herein. It relates to a system for determining whether the temperature of a brake is above or below a threshold, and warning a rider of a motorcycle when the temperature is below the threshold. Additionally, the system may control the brakes in such a way as to raise their temperature.

### B. Exemplary Embodiments

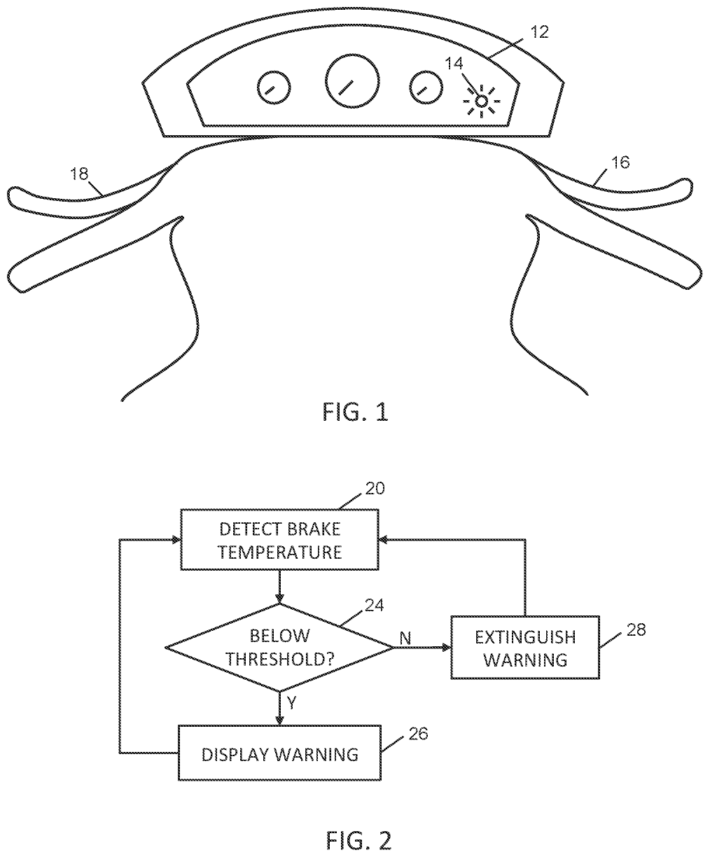

Referring to FIG. 1, a motorcycle cockpit is shown in which there is a dashboard 12 with a cold brake warning indicator 14 (hereinafter “indicator” for brevity). The indicator 14 is shown illuminated, indicating that the hydraulic brakes are not primed. There are two hydraulic brake levers. The right lever 16 is for the front brake and the left lever 18 is for the rear brake. The left lever operates both the rear hydraulic brake and the regenerative brake, which applies braking force to the rear wheel. The right lever 16 operates a hydraulic brake.

Referring to FIG. 2, a flowchart is shown for an exemplary cold brake warning system based on detecting the temperature of one or both of the hydraulic brakes. In detecting the temperature of a hydraulic brake, the temperature of the disc, a pad, or both the disc and a pad may be measured. In step 20, the system detects the temperature of the rear hydraulic brake, the front hydraulic brake or both the front and rear hydraulic brakes. In step 24, the system determines whether the temperature of one or both of the hydraulic brakes is below a threshold value, i.e. the priming threshold. If one or both of the hydraulic brakes has a temperature that is below the priming threshold, then, in step 26, the warning light 14 is illuminated on the dashboard 12 of the motorcycle.

The warning light 14 of the cold brake warning system is a notification type of communication to riders to allow them to anticipate and plan for an event such as when cold brakes are needed to slow down. For example, a rider may need to perform emergency braking before the brakes have been primed. By providing a warning indicator, the rider is not encumbered with tasks such as, for example, manually adjusting the ratio between hydraulic and regenerative braking strengths, which may need to be changed from time to time. Furthermore, the rider does not consciously need to take any particular action to prime the brake during a ride. The warning light merely communicates to the rider that extra brake pressure by the levers may be necessary as the brakes are cold, due to predominantly or entirely using regenerative braking or due to not using the hydraulic brakes. The illumination of the warning light increases the level of anticipation for the rider to adjust their braking pressure.

The warning light 14 may be illuminated in different modes. For example, when unprimed brakes are first detected, the warning light may flash for a set duration of time. After this duration of time, the warning light 14 may then change to a steady state of constant illumination. In some embodiments, the duration of the flashing mode may be adjusted in settings on the dashboard.

The cold brake warning light 14 is illuminated during riding. However, in some embodiments an additional message is shown on the dashboard when the rider is in a safer condition, such as parked or at a halt. The message may be a textual message, for example: “Cold Brakes”.

After the warning light has been switched on, the process then loops back to step 20. In step 20, the temperature of the brake or brakes may be continuously or intermittently sensed. In step 24, the system again determines whether the temperature of one or both of the hydraulic brakes is below a threshold value. If neither of the hydraulic brakes has a temperature that is below the threshold when the temperature of both is measured, or if the one brake for which the temperature has been measured is above the threshold then, in step 28, the warning light 14 on the dashboard 12 of the motorcycle is extinguished. When the warning light is extinguished, this indicates to the rider that the hydraulic brakes are primed, i.e. “warm” or “hot”. The process then again loops back to step 20.

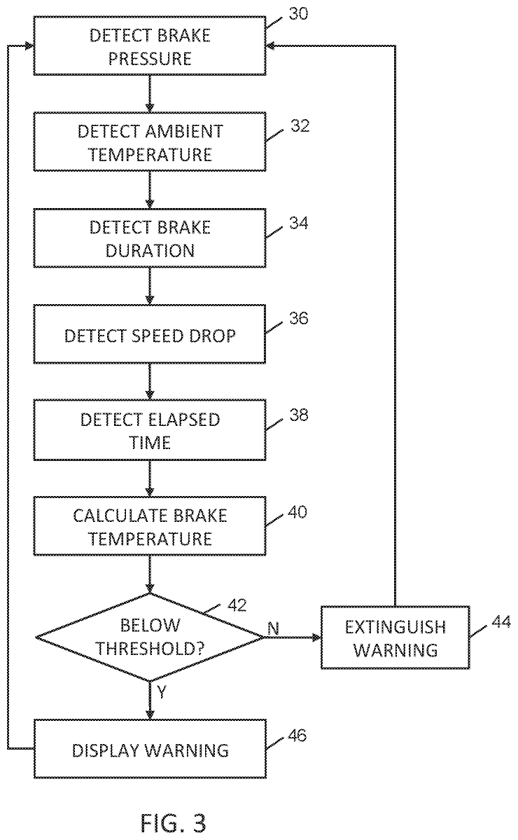

Referring to FIG. 3, a flowchart is shown for a process of another cold brake warning system, in which the temperature of the brakes does not need to be measured directly. This process may be employed instead of or as well as the process of FIG. 2. In step 30, the applied pressure of a hydraulic brake is detected. This may be achieved, for example, by a position sensor in a brake lever, by a force sensor in a mechanical component of the hydraulic brake, or by a pressure sensor that measures the pressure of the brake fluid of the hydraulic brake. In step 32, the ambient temperature is measured. This may be via a temperature sensor mounted on the motorcycle, for example. In step 34, the duration of a braking action is measured, for example using a timer and sensor that detects activation of the brake lever. In step 36, the speed drop resulting from the braking action is calculated, by comparing the speedometer readings before and after the braking action. In step 38, the elapsed time since the braking action ended is measured.

In step 40, the temperature of the brake is calculated, using some or all of the detected parameters from the prior steps. For example, the amount of kinetic energy converted to thermal energy as a result of the speed drop can be used to determine the rise in temperature of the brake, taking into account its heat capacity. The initial temperature may be taken to be the ambient temperature if sufficient time has passed without the hydraulic brake having been used. The time elapsed after the braking action and the ambient temperature can be used to calculate the temperature of the brake a certain period after the braking action, taking into account the rate of cooling of the brake. The brake pressure and the duration that the brake pressure is applied may be used to determine the friction applied to the brake, from which its temperature rise can be derived based on its heat capacity.

In step 42, the system determines whether the calculated temperature of one or both of the hydraulic brakes is below a threshold value. If one or both of the hydraulic brakes has a temperature that is below the threshold, then, in step 46, the warning light 14 is illuminated on the dashboard 12 of the motorcycle. The process then again loops back to step 30.

If neither of the hydraulic brakes has a temperature that is below the threshold when the temperature of both is calculated, or if the one brake for which the temperature has been measured is not below the threshold then, in step 44, the warning light 14 on the dashboard 12 of the motorcycle is extinguished. When the warning light is extinguished, this indicates priming of the hydraulic brake or brakes. The process then again loops back to step 30.

The process of FIG. 3 may be used as a secondary system to the direct measurement of the brake temperature, in the case of failure of the brake temperature sensor. It may be used to provide redundancy, to validate the reading from the brake temperature sensor. Other sensors and calculations may be incorporated to determine the temperature of the brakes. For example, an attitude sensor may determine that the motorcycle is going downhill or uphill when braking, and so the use of the speed drop in the calculation would be misleading. In this case, the speed drop is compensated for, or is not used in the calculation of the brake temperature.

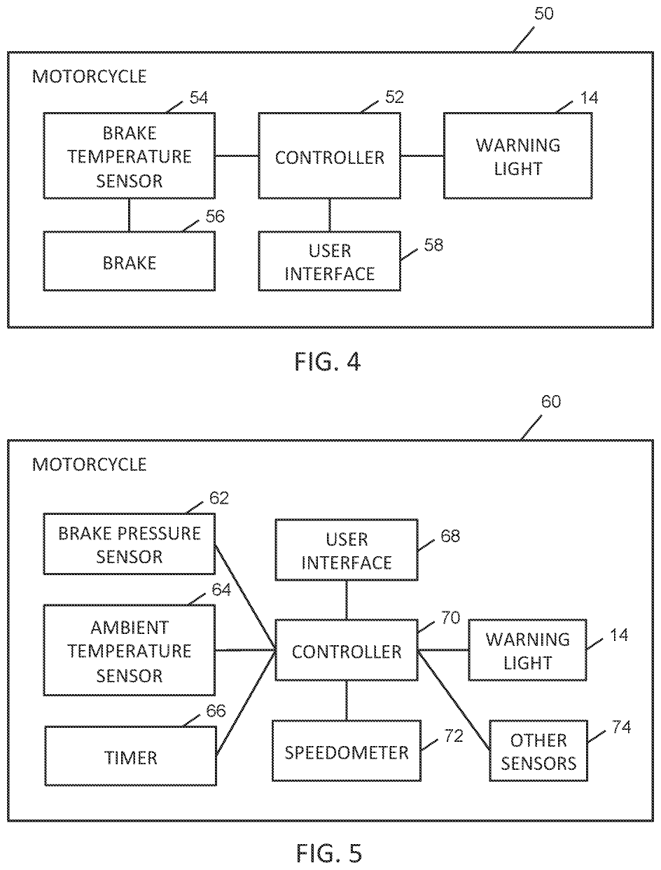

FIG. 4 is a block diagram of components of a motorcycle with a cold brake warning system that follows the process of FIG. 2. The motorcycle 50 includes a controller 52, which may be an electronic control unit (ECU) for the motorcycle, part of the ECU, or it may be a separate control unit. The controller 52 includes a processor and non-transitory computer-readable memory storing computer-readable instructions, which, when executed by the processor cause the cold brake warning system to function as described herein.

The controller 52 is connected to one or more brake temperature sensors 54, which measure the temperature of one or more of the brakes 56, specifically one or more of the brake discs and/or pads. The controller 52 is also connected to the warning light 14. Programming instructions within the controller 52 determine whether the warning light 14 should be illuminated or extinguished based on the temperature of the brakes or brakes.

The controller 52 is also connected to a user interface 58, which may be on the dashboard of the motorcycle. The rider may adjust the settings for the warning light via the user interface. In some embodiments, a setting of a transition point or strength ratio between the hydraulic brake and the regenerative brake can be adjusted.

FIG. 5 is a block diagram of components of a motorcycle with a cold brake warning system that follows the process of FIG. 3. The motorcycle 60 includes a controller 70, which may be an ECU for the motorcycle, part of an ECU, or it may be a separate control unit. The controller 70 includes a processor and non-transitory computer-readable memory storing computer-readable instructions, which, when executed by the processor cause the system to function as described herein.

The controller 70 is connected to one or more brake pressure sensors 62, an ambient temperature sensor 64, a timer 66, a user interface 68, a speedometer 72, other optional sensors 74 and the warning light 14. A brake pressure sensor 62 may be a position sensor for a brake lever, a force sensor in a mechanical component of the hydraulic brake, such as a caliper or piston, or a hydraulic fluid pressure sensor. The timer 66 may be a module within the controller 70, for example, or it may be a separate clock or timer. The user interface 68 may be on the dashboard of the motorcycle.

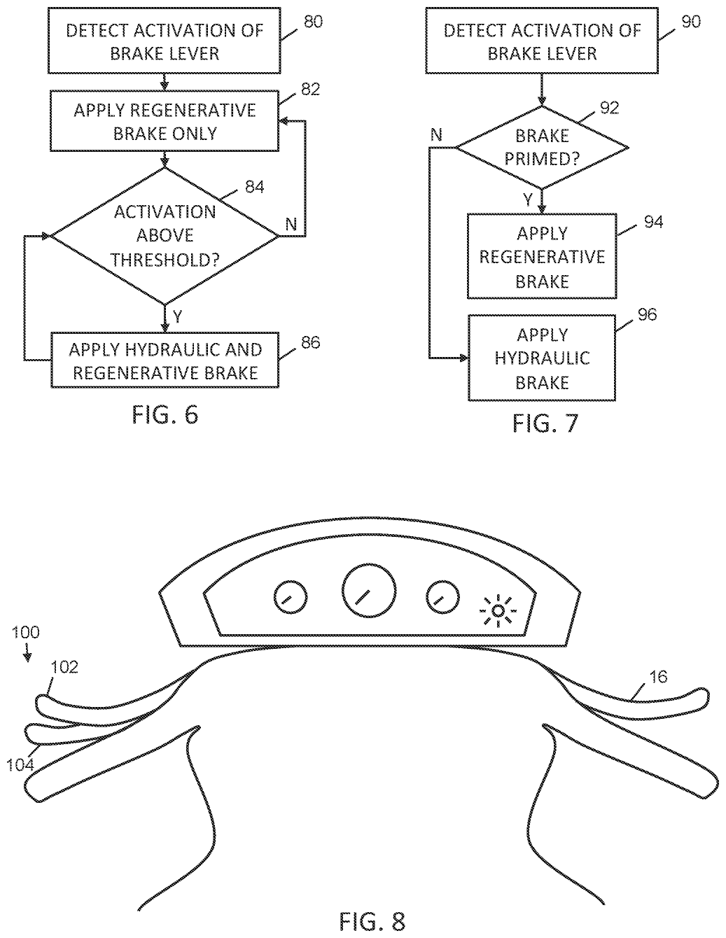

FIG. 6 is a flowchart for controlling the hydraulic and regenerative brakes using the left brake lever 18, while the brake lever is activated. In step 80, the system detects activation of the brake lever 18. In step 82, the regenerative brake is applied, but not the hydraulic brake. In step 84, the system determines whether the activation of the brake lever 18 is above a predetermined threshold. The level of activation may be determined by sensing an amount of depression of the brake lever. If the activation of the brake lever is above the threshold, then, in step 86, the hydraulic brake is applied in addition to the regenerative brake. The process reverts back to step 84, as the level of application of the brake lever is monitored continually. If, in step 84, the activation of the brake lever is below the threshold, then, the process reverts to step 82, in which only the regenerative brake is applied. When the brake lever is no longer activated, then the process stops and no brakes are applied. The process of FIG. 6 may be used only when the hydraulic brake is primed, or it may be used irrespectively of the temperature of the hydraulic brake.

The transition from regenerative only to combined regenerative and hydraulic braking is made smoothly so that the transition is imperceptible to the rider, or so close to imperceptible that it has no impact on the ride experienced by the rider and the safety of the ride. The lever and braking system are configured so that as more pressure is applied to the brake lever, the more rapidly the motorcycle will come to a stop, even though the specific braking mechanism may be transitioned between hydraulic and regenerative technologies.

FIG. 7 is a flowchart for controlling the hydraulic and regenerative brakes depending on the temperature of the brakes. In step 90, the system detects activation of the brake lever, which controls both the regenerative and hydraulic rear brakes. In step 92, the system determines whether the brakes are primed, by determining their temperature relative to the priming threshold. This may be both front and rear brakes or just the rear brake. If the rear brake is primed, then the process moves to step 94, in which the regenerative brake is applied. If the rear brake is not primed, then the process moves to step 96, in which the hydraulic brake is applied. By applying the hydraulic brake when it is not primed, it helps to raise the temperature of the brake so that it becomes primed.

Referring to FIG. 8, an example of a motorcycle with three brake levers is shown. The right hand lever 16 operates the front hydraulic brake. The left hand lever 100 is a combination lever, including an outer lever 102 that operates the rear regenerative brake and an inner lever 104 that operates the rear hydraulic brake. When the combination lever 100 is activated, only the outer lever 102 is depressed at first, until it reaches the inner lever 104, at which point both the outer lever and the inner lever are activated together. The inner lever 104 projects outwards beyond the end of the outer lever 102 so that the rider can actuate the inner lever 104 alone, so that the hydraulic rear brake is applied without the regenerative brake being applied.

### C. Variations

The brake levers may be configured differently to those shown herein. For example, they may be in different positions or they may operate different brakes. In some embodiments there are three brake levers. These are one for the front hydraulic brake, one for the hydraulic rear brake, and a third for the regenerative rear brake. In other embodiments, there are two brake levers. One is for the front hydraulic brake, and the other is for the hydraulic rear brake and regenerative rear brake combined.

The regenerative brake in some embodiments is controlled by a forward lever operated by the rider's forefingers or an aft lever operated by a rider's thumb. The rear hydraulic brake in some embodiments is controlled by a forward lever operated by the rider's forefingers or an aft lever operated by a rider's thumb. The regenerative and rear hydraulic brakes in some embodiments are controlled by a forward lever operated by the rider's forefingers or an aft lever operated by a rider's thumb.

For a brake lever that operates both the hydraulic and regenerative rear brakes, the regenerative brake may be activated when the brake lever is lightly depressed and there may be a threshold above which activation of the hydraulic brake begins. The threshold may be a distance through which the lever is depressed, or a force on the lever that must be exceeded. Fundamentally, the threshold of when the hydraulic braking system comes into effect is when the rider requires more deceleration at any moment in time than what the regenerative braking system can provide.

In some embodiments, the hydraulic brake is activated when the regenerative brake is providing its maximum braking force. In some embodiments, the hydraulic brake is activated when an increase in braking force is called for and the additional braking force provided by the regenerative brake does not increase proportionally, in line or as traditionally may be expected with the brake lever depression. In other words, when the braking response available from the regenerative brake starts to fall off, the hydraulic brake is activated to compensate. The relative proportion of braking force provided by the regenerative and hydraulic brakes may change depending on the amount of depression of the brake lever, and the change may be gradual.

In some embodiments the controller is configured to apply the rear hydraulic brake in preference to the rear regenerative brake when the temperature is below the priming threshold. This means that the rear hydraulic brake only is applied until the temperature of the brake rises above the priming threshold temperature. At or above this threshold temperature, the braking force is then provided by the regenerative brake, until such time as the temperature of the brake falls below the priming threshold. At or above the threshold temperature, the controller is therefore configured to apply the rear regenerative brake in preference to the rear hydraulic brake. If, in scenarios when the brake is primed and the regenerative brake cannot provide enough stopping power, then extra braking power is provided by the rear hydraulic brake. Additional braking power may also be provided by the front hydraulic brake in these scenarios. The controller is configured to control the brakes so that they transition smoothly between the two braking methods.

The illumination of the warning light 14 may be accompanied by an audible signal or a haptic signal. The haptic signal may be given to the rider via the handlebars, for example. In other embodiments, the haptic signal may be given to the rider via the brake levers and/or footpegs. The timing of the haptic signal or another haptic signal may be such that it is given to the rider the moment that the throttle is released, in anticipation of a braking action. The timing of the haptic signal may be such that it is given to the rider only if the throttle is released suddenly. The timing of the audio signal or another audio signal may be such that it is given to the rider the moment that the throttle is released. The timing of the audio signal may be such that it is given to the rider only if the throttle is released suddenly.

Further information may optionally be given to the rider on an information screen of the dashboard or in a user manual, such as charts, graphs and/or instructions to show when the hydraulic brakes are likely not to be primed, as a function of ambient temperature and traveling time without use of the hydraulic brakes.

In some embodiments, the rider may adjust the strength of the regenerative braking. This may be done by the rider adjusting a setting that limits the maximum regenerative braking force, e.g. by limiting the amount of current drawn from the motor when braking. For example, in colder climates, a rider may set the limit lower, so that hydraulic braking is used more than if the setting were higher. This would have the result of keeping the hydraulic brakes warmer on average than if the limit were higher. In some embodiments, the limit to the strength of the regenerative braking system may be adjusted during a ride. For example, the rider may be able to remove the limit using an easily-accessible switch, button or lever.

In some embodiments, the system may automatically adjust the hydraulic braking pressure on one or both wheels, the regenerative braking force, or any combination of these. This may be done, for example, on motorcycles with a forward collision sensor that calls for additional braking force in the event that it detects that a collision will occur unless evasive action is taken. However, outside of an imminent collision scenario, in some embodiments the system is configured so that the rider has full control over which of the three brakes is used and how much.

Using the sensors, the system may be configured to adjust the hydraulic-regenerative braking ratio automatically some of the time or all of the time. If automatic control is implemented all of the time, then a single brake lever may be used and the system balances the ratio between front and rear braking and between hydraulic and regenerative braking. All three brakes activate in combination and the right ratio between the strength of application of the three allows the motorcycle to brake with a combination of better balance and more energy efficiency than if the system were limited to using just one or two of the three brakes.

In some embodiments, the hydraulic brakes are used in preference to the regenerative brake until the temperature of the hydraulic brakes is high enough that the hydraulic brakes are primed. By operating the hydraulic brakes in preference to the regenerative brake means providing more than 50% of the braking force via the hydraulic brakes than via the regenerative brake. In some cases, 100% of the braking force is provided by the hydraulic brakes, or brake, and 0% by the regenerative brake.

By operating the regenerative brake in preference to the hydraulic brakes, where demanded, means providing more than 50% of the braking force via the regenerative brake than via the hydraulic brakes or brake. In some cases, 100% of the braking force is provided by the regenerative brake and 0% by the hydraulic brakes.

In some embodiments, the hydraulic brakes are applied gently (i.e. dragged) while the throttle is applied until such time as the hydraulic brakes are primed. For a given throttle setting, while dragging the hydraulic brakes to prime them, extra power is supplied to the motor to compensate for the drag. This results in a smooth and subtle action so that the rider cannot feel the difference, and there is no effect on the throttle control of the motorcycle. Furthermore, the drag on front and rear hydraulic brakes is balanced so that the motorcycle does not pitch forward or back, but remains level.

In some embodiments, the rider may disable the warning light 14.

In some embodiments there are two warning lights. One warning light is for the front hydraulic brake and the other is for the rear hydraulic brake.

In some embodiments, the threshold at which the warning light is illuminated depends on the speed of the motorcycle. For example, at higher speeds, the brakes will warm up faster when braking than when braking from lower speeds. As such, unprimed brakes will in general become primed more quickly when braking from higher speeds than from lower speeds. The threshold temperature used to determine whether the warning light is on or off may then be lower for higher speeds of the motorcycle compared to lower speeds of the motorcycle.

In general, unless otherwise indicated, singular elements may be in the plural and vice versa with no loss of generality.

Throughout the description, specific details have been set forth in order to provide a more thorough understanding of the invention. However, the invention may be practiced without these particulars. In other instances, well known elements have not been shown or described in detail and repetitions of steps and features have been omitted to avoid unnecessarily obscuring the invention. Accordingly, the specification is to be regarded in an illustrative, rather than a restrictive, sense.

The detailed description has been presented partly in terms of methods or processes, symbolic representations of operations, functionalities and features of the invention. These method descriptions and representations are the means used by those skilled in the art to most effectively convey the substance of their work to others skilled in the art. A software implemented method or process is here, and generally, understood to be a self-consistent sequence of steps leading to a desired result. These steps require physical manipulations of physical quantities. Often, but not necessarily, these quantities take the form of electrical or magnetic signals or values capable of being stored, transferred, combined, compared, and otherwise manipulated. It will be further appreciated that the lines between hardware, firmware and software are not always sharp, it being understood by those skilled in the art that the software implemented processes described herein may be embodied in hardware, firmware, software, or any combination thereof. Such processes may be controlled by coded instructions such as microcode and/or by stored programming instructions in one or more tangible or non-transient media readable by a computer or processor. The code modules may be stored in any computer storage system or device, such as hard disk drives, optical drives, solid state memories, etc. The methods may alternatively be embodied partly or wholly in specialized computer hardware, such as ASIC or FPGA circuitry.

It will be clear to one having skill in the art that further variations to the specific details disclosed herein can be made, resulting in other embodiments that are within the scope of the invention disclosed. Two or more steps in the flowcharts may be performed in a different order, other steps may be added, or one or more may be removed without altering the main function of the invention. Steps shown to occur in series may be changed to occur in parallel. Flowcharts from different figures may be combined in different ways. Modules may be divided into constituent modules or combined into larger modules. All configurations described herein are examples only and actual values of such depend on the specific embodiment. Accordingly, the scope of the invention is to be construed in accordance with the substance defined by the following claims.

1. A motorcycle comprising:
a rear hydraulic brake;
a rear regenerative brake;
an indicator; and
a controller, the controller configured to:
determine a temperature of the rear hydraulic brake;
illuminate the indicator when the temperature is below a priming threshold; and
extinguish the indicator when the temperature is above the priming threshold.

2. The motorcycle of claim 1 comprising a brake lever that operates both the rear hydraulic brake and the rear regenerative brake, wherein the controller is configured to:
detect a depression of the brake lever;
apply the rear hydraulic brake in preference to the rear regenerative brake when the temperature is below the priming threshold; and
apply the rear regenerative brake in preference to the rear hydraulic brake when the temperature is above the priming threshold.

3. The motorcycle of claim 1 comprising a brake lever that operates both the rear hydraulic brake and the rear regenerative brake, wherein the controller is configured to:
detect a depression of the brake lever;
apply the rear regenerative brake and not the hydraulic brake when the depression is less than a predetermined amount; and
apply the rear regenerative brake and the hydraulic brake when the depression is greater than the predetermined amount.

4. The motorcycle of claim 1 comprising a sensor that measures the temperature.

5. The motorcycle of claim 1 comprising one or more sensors from:
a position sensor in a brake lever that operates both the rear hydraulic brake and the rear regenerative brake;
a force sensor in a mechanical component of the hydraulic brake;
a brake fluid pressure sensor;
a speedometer;
an attitude sensor; and
an ambient temperature sensor;
wherein the controller uses one or more parameters detected by said one or more sensors to determine the temperature of the rear hydraulic brake.

6. The motorcycle of claim 1 comprising a haptic warning device, an audible warning device or both the haptic warning device and the audible warning device, wherein the controller is configured to activate one or both of the haptic warning device and the audible warning device when the indicator is illuminated.

7. The motorcycle of claim 1 comprising a user interface via which a setting of a transition point or strength ratio between the hydraulic brake and the regenerative brake can be adjusted.

8. The motorcycle of claim 1 comprising:
a brake lever that operates the rear hydraulic brake;
another brake lever that operates a front hydraulic brake of the motorcycle; and
a third brake lever that operates the rear regenerative brake.

9. The motorcycle of claim 1, wherein the controller is configured to drag the rear hydraulic brake when the temperature is below the priming threshold.

10. The motorcycle of claim 9, wherein the controller is configured to apply additional power to a rear wheel of the motorcycle while dragging the rear hydraulic brake, without affecting a throttle control of the motorcycle.

11. A motorcycle comprising:
a rear hydraulic brake;
a rear regenerative brake;
a front hydraulic brake;
an indicator; and
a controller, the controller configured to:
determine a temperature of the rear hydraulic brake;
determine a temperature of the front hydraulic brake;
illuminate the indicator when at least one of the temperature of the rear hydraulic brake and the temperature of the front hydraulic brake is below a priming threshold; and
extinguish the indicator when the temperature of the rear hydraulic brake and the temperature of the front hydraulic brake are above the priming threshold.

12. The motorcycle of claim 11 wherein the indicator is used solely for indicating that the rear hydraulic brake is below the priming threshold, and the motorcycle comprises another indicator that is used solely for indicating that the front hydraulic brake is below the priming threshold.

13. A method for warning a rider of a motorcycle that a hydraulic brake of the motorcycle is not primed comprising:
determining a temperature of the hydraulic brake;
determining that the temperature is below a priming threshold; and
illuminating an indicator on the motorcycle.

14. The method of claim 13, wherein the temperature is of a disc of the hydraulic brake or a pad of the hydraulic brake, and is determined by measurement, calculation or both measurement and calculation.

15. The method of claim 14 comprising sensing one or more parameters selected from a speed of the motorcycle, a pressure of the hydraulic brake, a duration of a braking action, a time elapsed after the braking action, an ambient temperature and an attitude of the motorcycle; and
using the one or more parameters to calculate the temperature.

16. The method of claim 13, comprising activating one or both of a haptic warning device and an audible warning device when the indicator is illuminated.

17. The method of claim 13, comprising activating one or both of a haptic warning device and an audible warning device when a throttle of the motorcycle is released and the temperature is below the priming threshold.

18. The method of claim 13, comprising:
detecting a depression of a brake lever that operates both the hydraulic brake and a regenerative brake;
applying the hydraulic brake in preference to the regenerative brake when the temperature is below the priming threshold; and
applying the regenerative brake in preference to the hydraulic brake when the temperature is above the priming threshold.

19. The method of claim 13, comprising:
detecting a depression of a brake lever that operates both the hydraulic brake and a regenerative brake;
applying the regenerative brake and not the hydraulic brake when the depression is less than a predetermined amount; and
applying the regenerative brake and the hydraulic brake when the depression is greater than the predetermined amount.
